(19) United States
(12) Patent Application Publication
(10) Pub. No.: US 2024/0208146 A1
(43) Pub. Date: Jun. 27, 2024

(54) MATERIAL GUIDE MECHANISM AND 3D PRINTER

(71) Applicant: SHENZHEN TUOZHU TECHNOLOGY CO., LTD., Shenzhen (CN)

(72) Inventor: Kaiwang TIAN, Shenzhen (CN)

(73) Assignee: SHENZHEN TUOZHU TECHNOLOGY CO., LTD., Shenzhen (CN)

(21) Appl. No.: 18/599,132

(22) Filed: Mar. 7, 2024

Related U.S. Application Data
(63) Continuation of application No. PCT/CN23/71679, filed on Jan. 10, 2023.

(30) Foreign Application Priority Data
Jan. 17, 2022 (CN) 202210050222.9

(51) Int. Cl. B29C 64/321; B29C 64/118; B33Y 30/00

(52) U.S. Cl. CPC B29C 64/321; B29C 64/118; B33Y 30/00

(57) ABSTRACT

A filament guide mechanism and a 3D printer. The filament guide mechanism comprises: a housing, the housing defining multiple filament entries, multiple filament feed channels, a filament exit, and a filament discharge channel. Each of the multiple filament feed channels communicates with a corresponding filament entry among the multiple filament entries so as to receive corresponding filament that is wound on a corresponding filament spool; the filament discharge channel communicates with the filament exit; the filament exit is used to connect to the main filament guide tube; and the multiple filament feed channels are connected to the filament exit by means of the filament discharge channel. The housing has a housing curvature.

### CROSS-REFERENCE TO RELATED APPLICATIONS

This application is a continuation of International Patent Application No. PCT/CN2023/071679, filed on Jan. 10, 2023, which claims priority to Chinese Patent Application No. 202210050222.9, filed on Jan. 17, 2022. The disclosures of the aforementioned applications are hereby incorporated by reference in their entireties.

### TECHNICAL FIELD

The present disclosure relates to the field of three-dimensional (3D) printing technology, and in particular to a filament guide mechanism and a 3D printer.

### BACKGROUND

3D printing technology, also known as additive manufacturing, is a technique for building objects by layer-by-layer printing using bondable materials based on digital model files. 3D printing is typically achieved by using a 3D printer. A 3D printer, also known as a three-dimensional printer or an additive manufacturing device, is a process equipment for rapid prototyping. A typical 3D printing technology is fused deposition modeling (FDM). A working principle of FDM is that a hot melt nozzle moves in a horizontal plane under the control of a computer according to the cross section profile information of a product part, a thermoplastic linear material is delivered to the hot melt nozzle by a feeding mechanism, the molten material is extruded from the nozzle and deposited on a print table, and a layer of sheet profile is formed after the molten material is rapidly cooled. After the cross section of one layer is formed, the print table moves for a certain distance in the vertical direction, then cladding of the next layer is carried out, and the process is circulated, so that the three-dimensional product part is finally formed.

The approaches described in this section are not necessarily approaches that have been previously conceived or pursued. Unless otherwise indicated, it should not be assumed that any of the approaches described in this section qualify as prior art merely by virtue of their inclusion in this section. Similarly, unless otherwise indicated, the problems mentioned in this section should not be considered as having been acknowledged in any prior art.

### SUMMARY

According to an aspect of the present disclosure, provided is a filament guide mechanism for communicating with a main filament guide tube in a 3D printer to guide a filament from different filament spools to the main filament guide tube. The filament guide mechanism comprises: a housing defining a plurality of filament entries, a plurality of filament feed channels, a filament exit, and a filament discharge channel, wherein each of the plurality of filament feed channels communicates with a corresponding filament entry of the plurality of filament entries, respectively, to receive a corresponding filament wound around on a corresponding filament spool, the filament discharge channel communicates with the filament exit, the filament exit is used for attaching to the main filament guide tube, and the plurality of filament feed channels all communicate via the filament discharge channel with the filament exit, and wherein the housing is formed to have a housing curvature so that a corresponding combined channel formed by combining each of the plurality of filament feed channels and the filament discharge channel has a curvature to accommodate the curvature that the corresponding filament has after released from the corresponding filament spool.

The number of the plurality of filament entries is the same as the number of the plurality of filament feed channels.

The housing has a housing curvature relative to the plane defined by the center of the filament exit and the centers of any two of the plurality of the filament entries.

According to another aspect of the present disclosure, provided is a 3D printer, which comprises a printing head, a main filament guide tube, and the filament guide mechanism described above.

Additional aspects and advantages of the present disclosure will be set forth in part in the following description and, in part, will be apparent from the following description, or may be learned by practice of the present disclosure.

### BRIEF DESCRIPTION OF THE DRAWINGS

The above and/or additional aspects and advantages of the present disclosure will become apparent and readily understood from the following description of embodiments in conjunction with the accompanying drawings.

In the accompanying drawings, unless otherwise specified, the same reference numerals across multiple accompanying drawings indicate the same or similar components or elements. The accompanying drawings are not necessarily drawn to scale. It should be understood that the accompanying drawings depict only some embodiments in accordance with the present disclosure and are therefore not to be considered limiting of the scope of the present application.

FIG. 1 shows a schematic diagram of a filament guide mechanism, a filament spool, and a secondary filament guide tube according to an embodiment of the present disclosure.

FIG. 2 shows a schematic diagram of the filament guide mechanism in FIG. 1 according to an embodiment of the present disclosure.

FIG. 3 shows a cross-sectional view of the filament guide mechanism in FIG. 1 according to an embodiment of the present disclosure.

FIG. 4 shows a schematic diagram of a filament guide mechanism according to an embodiment of the present disclosure.

FIG. 5 shows a top view of the filament guide mechanism in FIG. 4 according to an embodiment of the present disclosure.

FIG. 6 shows a cross-sectional view taken along the line B-B′ in FIG. 5 of the filament guide mechanism according to an embodiment of the present disclosure.

FIG. 7 shows a top view of a cross-section of the filament guide mechanism in FIG. 4 according to an embodiment of the present disclosure.

### DETAILED DESCRIPTION

In the following, only certain exemplary embodiments are briefly described. The description is to be construed as illustrative in nature but not restrictive.

In 3D printing processes, there may be a need for multiple printing materials. For example, when printing the same object, different types of printing materials may be required to print different portions of the object. Generally, different types of linear printing materials (also called as a filament) are wound in different filament spools, and the filament needs to be extracted from the different filament spools to perform a printing operation. The applicant has found that the filament to be printed extracted from different filament spools is usually bent to some extent due to plastic deformation of the filament wound in the filament spool, the bent filament, after entering a 3D printer, may contact with various components of the 3D printer to generate a relatively large frictional force, and the excessive frictional force may hinder the movement of the filament in the components, affect the accuracy of the feeding amount supplied to the printing head, and reduce the printing quality.

Based on this, in the embodiments of the present disclosure, provided is a filament guide mechanism, wherein the housing of the filament guide mechanism is formed to have a housing curvature relative to the plane defined by the center of the filament exit and the centers of any two of the plurality of the filament entries, so that a corresponding combined channel formed by combining the plurality of filament feed channels and the filament discharge channel of the filament guide mechanism accommodates the curvature that the filament has after released from the corresponding filament spool, thereby reducing the frictional force of the filaments from a plurality of filament spools on the filament guide mechanism and improving the printing quality.

Embodiments of the present disclosure will be described in detail below with reference to the accompanying drawings.

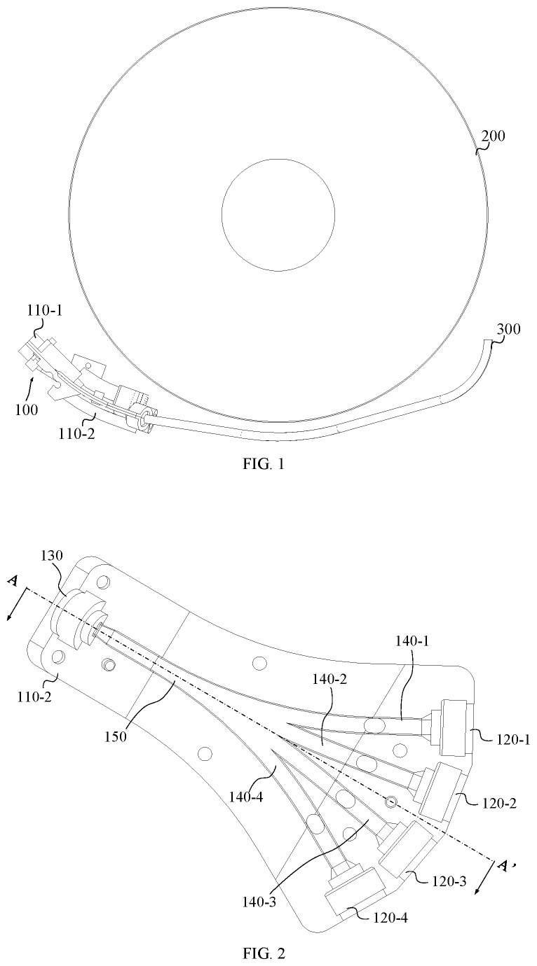

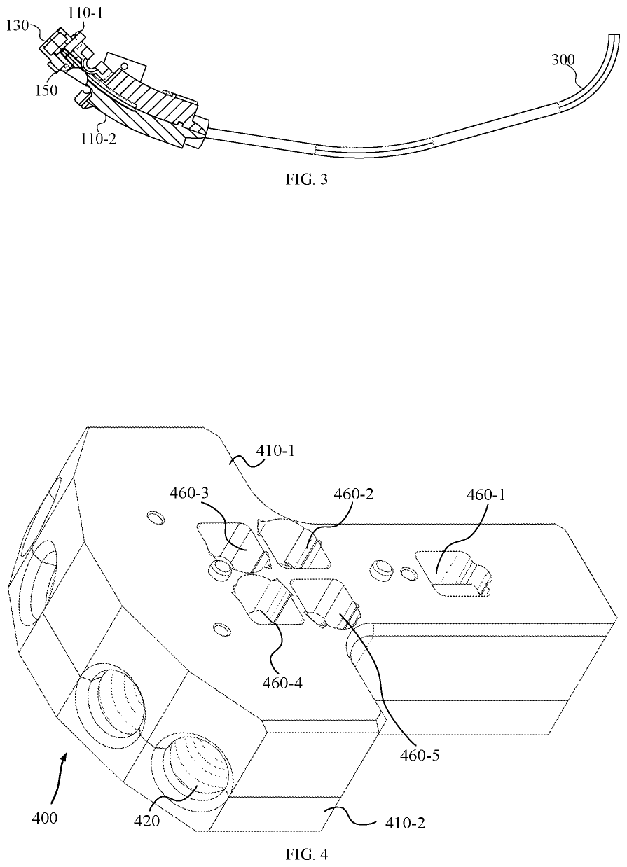

Reference is first made to FIG. 1 to FIG. 3. FIG. 1 shows a schematic diagram of a filament guide mechanism 100, a filament spool 200, and a secondary filament guide tube 300 according to an embodiment of the present disclosure, FIG. 2 shows a schematic diagram of the filament guide mechanism 100 in FIG. 1 according to an embodiment of the present disclosure, and FIG. 3 shows a cross-sectional view of the filament guide mechanism 100 in FIG. 1 according to an embodiment of the present disclosure.

Referring to FIG. 1, the filament guide mechanism 100 is connected to the secondary filament guide tube 300, and the secondary filament guide tube 300 is used for delivering a filament from the filament spool 200 to the filament guide mechanism 100. The filament guide mechanism 100 is used for communicating with a main filament guide tube (not shown in the figure) in a 3D printer to guide a filament from different filament spools to the main filament guide tube. The main filament guide tube may communicate with the printing head.

Here, for clarity, the filament is not shown in FIG. 1, only the secondary filament guide tube 300 for delivering the filament is shown, and only one filament spool 200 and one corresponding secondary filament guide tube 300 are shown. It should be understood that there are also a plurality of filament spools and a plurality of secondary filament guide tubes during use, the plurality of secondary filament guide tubes separately deliver a filament from the corresponding filament spool to the filament guide mechanism 100, and the filament guide mechanism 100 guides the filament to the main filament guide tube, thereby meeting different printing requirements.

Referring to FIG. 1 to FIG. 3 again, the filament guide mechanism 100 comprises housings 110-1 and 110-2. The housings 110-1 and 110-2 define a plurality of filament entries 120-1, 120-2, 120-3, and 120-4; a filament exit 130; a plurality of filament feed channels 140-1, 140-2, 140-3, and 140-4, and a filament discharge channel 150.

Each of the plurality of filament feed channels 140-1, 140-2, 140-3, and 140-4 communicates with a corresponding filament entry of the plurality of filament entries 120-1, 120-2, 120-3, and 120-4, respectively, to receive a corresponding filament wound around on a corresponding filament spool (e.g., filament spool 200), the filament discharge channel 150 communicates with the filament exit 130, the filament exit 130 is used for attaching to the main filament guide tube (not shown in the figure), and the plurality of filament feed channels 140-1, 140-2, 140-3, and 140-4 all communicate via the filament discharge channel 150 with the filament exit 130.

The housings 110-1 and 110-2 are formed to have a housing curvature relative to the plane defined by the center of the filament exit 130 and the centers of any two of the plurality of the filament entries 120-1, 120-2, 120-3, and 120-4, so that a corresponding combined channel formed by combining each of the plurality of filament feed channels 140-1, 140-2, 140-3, and 140-4 and the filament discharge channel 150 accommodates the curvature that the corresponding filament has after released from the corresponding filament spool. Thus, the frictional force of the filaments from a plurality of filament spools on the filament guide mechanism 100 can be reduced, and the printing quality can be improved. Moreover, the filament powder and chips produced from friction can be reduced, thereby reducing or avoiding the jam of the powder and chips to the parts of the 3D printer.

It should be understood that the center of the filament exit 130 may be the geometric center of the planar shape of the filament exit 130. In one example, if the planar shape of the filament exit 130 is circular, the center of the filament exit 130 may be the center of the circle. Similarly, the center of the filament entry (e.g., filament entry 120-1) may be the geometric center of the planar shape of the filament entry (e.g., filament entry 120-1). Other definitions of “center” are possible, such as the center of mass. Any two of the plurality of filament entries 120-1, 120-2, 120-3, and 120-4 may be, for example, filament entries 120-1 and 120-2, or filament entries 120-1 and 120-3, or filament entries 120-2 and 120-4, which is not described herein again.

The housing curvature described above can be clearly seen in FIG. 1 and FIG. 3. The cross-sectional direction of the cross-sectional view shown in FIG. 3 is the direction of the cross-section A-A′ as shown in FIG. 2. It can be seen from FIG. 3 that the filament discharge channel 150 has approximately the same curvature as the housing curvature. In addition, each of the plurality of filament feed channels 140-1, 140-2, 140-3, and 140-4 also has approximately the same curvature as the housing curvature. A corresponding combined channel (i.e., an internal cavity) formed by combining each of the filament feed channels and the filament discharge channel accommodates the curvature that the corresponding filament has after released from the corresponding filament spool. It should be understood that the curvature that the filament has after released from the filament spool may not be a fixed value, but fall within a range of values. As mentioned above, the filament is plastically deformed to be bent due to being wound into the filament spool. When the filament is released from the corresponding filament spool, the filament will also have a certain curvature under the elastic action of the filament itself. Thus, as used herein, the term “the combined channel accommodates the curvature of the filament” may mean that the combined channel has a curvature that is within a range of possible values of the curvature that the filament has after released from the filament spool. As an example, curvature can be represented as the reciprocal of the radius of curvature, and the curvature of an arc is typically the average of the curvature of each segment of the arc.

According to some embodiments, the housing curvature may have a value that is no less than 60% of the minimum curvature that the filament wound around on the different filament spools has after released from each of the filament spools and no greater than 140% of the maximum curvature that the filament wound around on the different filament spools has after released from each of the filament spools. Through a plurality of tests, the applicant has found that the frictional force of the filaments from a plurality of filament spools on the filament guide mechanism 100 can be greatly reduced by setting the value of the housing curvature within the above range, which is therefore beneficial.

According to some embodiments, the housing curvature may have a value that is the statistical average of the curvature that the filament wound around on the different filament spools has after released from each of the filament spools. Thus, when the curvature that the filament on the different filament spools has after released from each of the filament spools is different or has a relatively large difference, the value of the housing curvature is set to be the statistical average that the filament wound around on the different filament spools has after released from each of the filament spools, so that the combined channel can better accommodate the different curvature that the filament has after released from the corresponding filament spool, thereby minimizing the frictional force of the filaments from the plurality of filament spools on the filament guide mechanism 100, further improving the printing quality, and reducing the filament powder and chips produced from friction.

According to some embodiments, at least one of the plurality of filament feed channels 140-1, 140-2, 140-3, and 140-4 may comprise an arcuate segment extending along an arc, and the at least one filament feed channel communicates through the arcuate segment with the filament discharge channel 150. As shown in FIG. 2, the filament feed channels 140-1 and 140-4 comprise an arcuate segment extending along an arc. The filament feed channels 140-1 and 140-4 communicate with the filament discharge channel 150, respectively, through their respective arcuate segments. Thus, while ensuring that the filament from different filament spools can be guided to the filament discharge channel 150 and further to the main filament guide tube, the arcuate segment can further reduce the friction of the filament entering the filament guide mechanism 100 from the corresponding filament feed channel on the inner walls of the channel, thereby further improving the printing quality and reducing the filament powder and chips produced from friction.

According to some embodiments, referring to FIG. 2 again, the plurality of filament feed channels 140-1, 140-2, 140-3, and 140-4 and the filament discharge channel 150 may each comprise a straight segment extending along a straight line, and the included angle between the axis of the straight segment of each of the filament feed channels and the axis of the straight segment of the filament discharge channel is an obtuse angle. In practice, the obtuse angle may be as close to 180 degrees as possible. Thus, the friction of the filament on the inner walls of the channel can be further reduced, thereby further improving the printing quality and reducing the filament powder and chips produced from friction.

According to some embodiments, referring to FIG. 2 again, the axis of the straight segment of the plurality of filament feed channels 140-1, 140-2, 140-3, and 140-4 may be in the same plane. In the example of FIG. 2, the connecting line of the centers of the plurality of filament entries 120-1, 120-2, 120-3, and 120-4 is an arc. In other examples, the connecting line of the centers of the plurality of filament entries may be a straight line or other two-dimensional patterns.

According to some embodiments, the axis of the straight segment of the plurality of filament feed channels 140-1, 140-2, 140-3, and 140-4 may not be coplanar. For example, if there are 3 filament entries, the 3 filament entries may be arranged in the form of triangle; if there are 4 filament entries, the 4 filament entries may be distributed in a grid of 2×2.

The filament guide mechanism according to an embodiment of the present disclosure will be further described below with reference to FIG. 4 to FIG. 7.

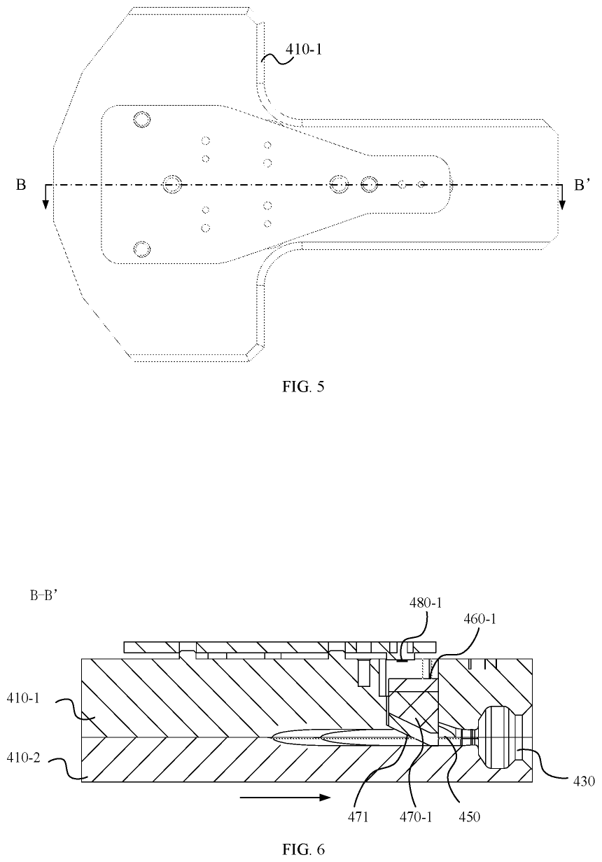

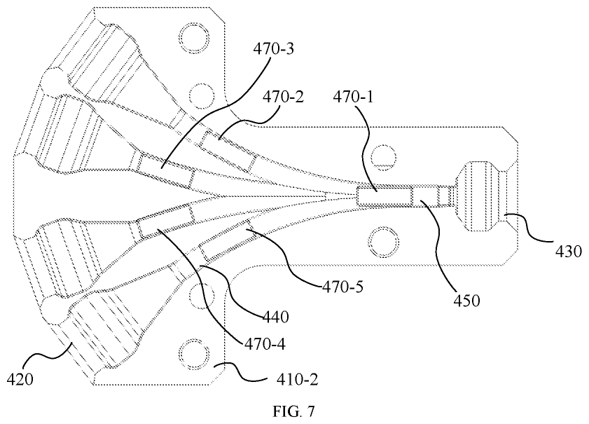

FIG. 4 shows a schematic diagram of a filament guide mechanism 400 according to an embodiment of the present disclosure, FIG. 5 shows a top view of the filament guide mechanism 400 in FIG. 4 according to an embodiment of the present disclosure, FIG. 6 shows a cross-sectional view taken along the line B-B′ in FIG. 5 of the filament guide mechanism 400 according to an embodiment of the present disclosure, and FIG. 7 shows a top view of a cross-section of the filament guide mechanism 400 in FIG. 4 according to an embodiment of the present disclosure.

The filament guide mechanism 400 shown in FIG. 4 to FIG. 7 comprises housings 410-1 and 410-2, and further comprises a filament entry 420, a filament exit 430, a filament feed channel 440, and a filament discharge channel 450. Here, the housings 410-1 and 410-2, the filament entry 420, the filament exit 430, the filament feed channel 440, and the filament discharge channel 450 are similar to the housings, the filament entry, the filament exit, the filament feed channel, and the filament discharge channel of the filament guide mechanism 100 described above with reference to FIG. 1 to FIG. 3, and are not described herein again.

According to some embodiments, the filament guide mechanism 400 may further comprise at least one sensor (e.g., sensor 480-1), the sensor 480-1 being arranged on the wall of the housing 410-1 for detecting the position of the filament end of the filament in the filament guide mechanism 400.

According to some embodiments, the plurality of filament feed channels 420 and the filament discharge channel 450 form an internal cavity of the housings 410-1 and 410-2, and at least one hole 460-1, 460-2, 460-3, 460-4, and 460-5 in communication with the internal cavity is provided in the wall of the housings 410-1 and 410-2. Moreover, the filament guide mechanism 400 may further comprise at least one trigger member 470-1, 470-2, 470-3, 470-4, and 470-5 arranged in the holes 460-1, 460-2, 460-3, 460-4, and 460-5, respectively. Each of the trigger member(s) is movably inserted into the internal cavity along the axial direction of a corresponding hole. One end, inserted into the internal cavity, of each of the trigger member(s) 470-1, 470-2, 470-3, 470-4, and 470-5 is formed to have an end surface at an angle to the feeding direction, so that when the filament in the internal cavity is guided to the position of the trigger member along the feeding direction (the direction indicated by the arrow in FIG. 6), the filament end of the filament directly presses the end surface of the end, thereby pushing the trigger member to move to a preset position (e.g., a position 8 millimeters upwards) in the corresponding hole. Each of the sensor(s) is arranged to cooperate with a corresponding trigger member so that when the corresponding trigger member moves to the preset position, the sensor is triggered to indicate that the filament in the internal cavity is guided in the feeding direction to the position of the trigger member. As can be seen in the cross-sectional view of FIG. 6, the sensor 480-1 is arranged to cooperate with the trigger member 470-1 so that the sensor 480-1 can be triggered when the trigger member 470-1 is moved to the preset position (e.g., a position 8 millimeters upwards). Thus, the position of the filament end of the filament in the filament guide mechanism 400 can be detected efficiently.

It should be understood that although 4 filament entries 420 and 4 filament feed channels 440 are shown in FIG. 4 to FIG. 7, the filament guide mechanism 400 may further comprise 1, 2, 3, 5, or more filament entries 420; accordingly, the filament guide mechanism 400 may further comprise 1, 2, 3, 5, or more filament feed channels 440.

It should also be understood that although 5 trigger members (470-1, 470-2, 470-3, 470-4, and 470-5) and 5 holes (460-1, 460-2, 460-3, 460-4, and 460-5) are shown in FIG. 4 to FIG. 7, the filament guide mechanism 400 may further comprise 1, 2, 3, 4, 6, or more trigger members; accordingly, the filament guide mechanism 400 may further comprise 1, 2, 3, 4, 6, or more holes for arranging the corresponding trigger members; accordingly, the filament guide mechanism 400 may further comprise 1, 2, 3, 4, 6, or more sensors.

According to some embodiments, the at least one sensor 480-1 may be at least one Hall sensor, and the at least one trigger member may be at least one magnet.

The filament does not directly contact with the Hall sensor, but through impelling the magnet motion, the Hall sensor is triggered through Hall effect by the magnet, so that when friction between the internal cavity and the filament produces powder and chips, the powder and chips cannot adhere or pile up on the Hall sensor, therefore the powder and chips cannot produce adverse effects to the detection of the Hall sensor. Thus, the accuracy and the reliability of detecting the position of the filament end of the filament to be printed in the filament guide mechanism can be improved.

According to some embodiments, the at least one sensor 480-1 may be at least one travel switch. Accordingly, the at least one trigger member may be at least one pin, cylinder, or trigger member of other shapes. This combination has a relatively simple construction, facilitating maintenance of the filament guide mechanism 400.

According to some embodiments, the at least one sensor 480-1 is a plurality of sensors, and the plurality of sensors may be respectively arranged on the wall of the housing at positions corresponding to the plurality of filament feed channels and the filament discharge channel. Thus, if the filament from a plurality of different filament spools need to be switched, when the sensor arranged at the filament discharge channel and the sensor arranged at one filament feed channel detect that the filament has been retracted from the filament discharge channel to one filament feed channel, the filament in other filament feed channels can be controlled to enter the filament discharge channel through the corresponding control mechanism, so that the filament from a plurality of different filament spools can be switched at the filament guide mechanism 400.

In the case of using a Hall sensor and using a magnet as a trigger member, when a plurality of magnets are arranged in the filament guide mechanism 400 and the relative positions of the plurality of magnets are relatively close to each other, if one magnet (e.g., magnet 470-2 in FIG. 7) is moved by the push of the filament, the magnet 470-1 may also be moved by a magnetic force due to, for example, the interaction between the magnetic field generated by the magnet 470-2 and the magnetic field generated by the magnet 470-1, although the filament does not pass by and push the magnet 470-1 at this time. This may lead to erroneous detection results.

Therefore, in some embodiments, the filament guide mechanism 400 may further comprise at least one stopping member (not shown in the figure), wherein each of the stopping member(s) may be arranged at one end of a corresponding hole (e.g., hole 460-1 in FIG. 6) of the at least one hole distal to the internal cavity for applying a force to a corresponding magnet (e.g., magnet 470-1 in FIG. 6) of the at least one magnet that prevents the corresponding magnet (e.g., magnet 470-1 in FIG. 6) from moving toward the preset position. If the magnet 470-1 tends to move upward under the action of the magnetic field generated by the magnet 470-2, the magnet 470-1 cannot move upward under the action of the stopping member due to the arrangement of the stopping member, and thus the Hall sensor 480-1 will not be triggered to generate an erroneous detection result. The amount of force generated by the stopping member may be set to be capable of resisting such undesired movement of the magnet, but allow movement of the magnet under the push force of the filament.

In some embodiments, each stopping member may be a spring. The spring may apply an elastic force to the magnet 470-1, thereby preventing the corresponding magnet 470-1 from moving toward the preset position.

In some embodiments, each stopping member may be a magnet that is magnetically repulsive to the corresponding magnet 470-1, which may exert a repulsive magnetic force, thereby preventing the corresponding magnet 470-1 from moving toward the preset position.

According to another aspect of the present disclosure, further provided is a 3D printer, which comprises a printing head, a main filament guide tube communicated with the printing head, and the filament guide mechanism 100 or 400 described above.

It should be understood that in this specification, terms such as “center”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise”, “counterclockwise”, “axial”, “radial”, “circumferential” and other directional or positional or dimensional indications are based on the orientations or position or dimension shown in the accompanying drawings. These terms are used merely to facilitate the description. These terms do not suggest or imply that the device or elements indicated must have specific orientations, or be constructed or operated in specific orientations, and therefore should not be construed as limiting the protection scope of the present application.

In addition, the terms “first”, “second” and “third” are only for the purpose of description, and may not be construed as indicating or implying the relative importance or implicitly indicating the number of technical features denoted. Thus, features defined by “first”, “second” and “third” may explicitly or implicitly include one or more of the features. In the description of the present application, “plurality” refers to two or more, unless otherwise explicitly and specifically defined.

In the present application, unless otherwise clearly specified and defined, the terms “mount”, “link”, “connect”, “fasten” and the like should be comprehended in their broad sense. For example, “connect” may be “fixedly connect”, “detachably connect” or “integrally connected as one”; “mechanically connect”, “electrically connect” or “communicate”; “directly interconnect” or “indirectly interconnect through an intermediate”; or “the communication between the interiors of two elements” or “the interaction between two elements”. For those of ordinary skill in the art, the specific meanings of the aforementioned terms in the present application can be interpreted according to specific conditions.

Unless otherwise explicitly stated or defined herein, the recitation of a first feature “on” or “under” a second feature may include the recitation of the first and second features being in direct contact, and may also include the recitation that the first and second features are not in direct contact, but are in contact via another feature between them. Moreover, a first feature “on”, “above” and “over” a second feature includes a first feature being directly above and obliquely above a second feature, or simply indicates that a horizontal height of a first feature is higher than that of a second feature. A first feature “beneath”, “under” and “below” a second feature includes a first feature being directly under and obliquely under a second feature, or simply indicates that a horizontal height of a first feature is smaller than that of a second feature.

What is claimed is:

1. A filament guide mechanism for communicating with a main filament guide tube in a 3D printer to guide a filament from different filament spools to the main filament guide tube, the filament guide mechanism comprising:
a housing defining a filament exit, a filament discharge channel, a plurality of filament entries, and a plurality of filament feed channels, wherein
each of the plurality of filament feed channels communicates with a corresponding filament entry of the plurality of filament entries, respectively, to receive a corresponding filament wound around on a corresponding filament spool,
an amount of the plurality of filament entries is the same as that of the plurality of filament feed channels, the filament discharge channel communicates with the filament exit, the filament exit is used for attaching to the main filament guide tube, and
the plurality of filament feed channels all communicate via the filament discharge channel with the filament exit; and, wherein the housing has a housing curvature so that a corresponding combined channel formed by combining each of the plurality of filament feed channels and the filament discharge channel has a curvature to accommodate the curvature that the corresponding filament has after released from the corresponding filament spool.

2. The filament guide mechanism according to claim 1, wherein the housing curvature has a value that is no less than 60% of the minimum curvature that the filament wound around on the different filament spools has after released from each of the filament spools and no greater than 140% of the maximum curvature that the filament wound around on the different filament spools has after released from each of the filament spools.

3. The filament guide mechanism according to claim 1, wherein the housing curvature has a value being a statistical average of the curvature that the filament wound around on the different filament spools has after released from each of the filament spools.

4. The filament guide mechanism according to claim 1, wherein at least one of the plurality of filament feed channels comprises an arcuate segment extending along an arc, and the at least one of the filament feed channels communicates through the arcuate segment with the filament discharge channel.

5. The filament guide mechanism according to claim 1, wherein the plurality of filament feed channels and the filament discharge channel each comprise a straight segment extending along a straight line, and an included angle between an axis of the straight segment of each of the filament feed channels and the axis of the straight segment of the filament discharge channel is an obtuse angle.

6. The filament guide mechanism according to claim 5, wherein the axes of the straight segments of the plurality of filament feed channels are in the same plane or are not coplanar.

7. The filament guide mechanism according to claim 1, further comprising at least one sensor arranged on a wall of the housing for detecting a position of the filament end of the filament in the filament guide mechanism.

8. The filament guide mechanism according to claim 7, wherein the plurality of filament feed channels and the filament discharge channel form an internal cavity of the housing, and at least one hole in communication with the internal cavity is provided on the wall of the housing, and the filament guide mechanism further comprises:
at least one trigger member, the at least one trigger member is respectively arranged in the at least one hole, each of the trigger member(s) is movably inserted into the internal cavity along an axial direction of a corresponding hole in the at least one hole, wherein one end, inserted into the internal cavity, of each of the trigger member(s) is formed to have an end surface at an angle to the feeding direction, so that when the filament in the internal cavity is guided to the position of the trigger member along the feeding direction, the filament end of the filament directly presses the end surface of the end, thereby pushing the trigger member to move to a preset position in the corresponding hole, and
each of the sensor(s) is arranged to cooperate with a corresponding trigger member of the at least one trigger member so that when the corresponding trigger member moves to the preset position, the sensor is triggered to indicate that the filament in the internal cavity is guided in the feeding direction to the position of the trigger member.

9. The filament guide mechanism according to claim 8, wherein the at least one sensor is at least one Hall sensor, and the at least one trigger member is at least one magnet.

10. The filament guide mechanism according to claim 8, wherein the at least one sensor is at least one travel switch.

11. The filament guide mechanism according to claim 7, wherein the at least one sensor is one in the plurality of sensors, and the plurality of sensors are respectively arranged the housing at positions corresponding to the plurality of filament feed channels and the filament discharge channel.

12. The filament guide mechanism according to claim 9, further comprising at least one stopping member, wherein each of the stopping member(s) is arranged at one end of a corresponding hole of the at least one hole distal to the internal cavity for applying a force to a corresponding magnet of the at least one magnet that prevents the corresponding magnet from moving toward the preset position.

13. A 3D printer, comprising:
a printing head;
a main filament guide tube communicated with the printing head, wherein the main filament guide mechanism comprises:
a housing defining a filament exit, a filament discharge channel, a plurality of filament entries, and a plurality of filament feed channels, wherein each of the plurality of filament feed channels communicates with a corresponding filament entry of the plurality of filament entries, respectively, to receive a corresponding filament wound around on a corresponding filament spool, an amount of the plurality of filament entries is the same as that of the plurality of filament feed channels, the filament discharge channel communicates with the filament exit, the filament exit is used for attaching to the main filament guide tube, and the plurality of filament feed channels all communicate via the filament discharge channel with the filament exit; and, wherein the housing has a housing curvature so that a corresponding combined channel formed by combining each of the plurality of filament feed channels and the filament discharge channel has a curvature to accommodate the curvature that the corresponding filament has after released from the corresponding filament spool.

14. The 3D printer according to claim 13, wherein the housing curvature has a value that is no less than 60% of the minimum curvature that the filament wound around on different filament spools has after released from each of the filament spools and no greater than 140% of the maximum curvature that the filament wound around on the different filament spools has after released from each of the filament spools.

15. The 3D printer according to claim 13, wherein at least one of the plurality of filament feed channels comprises an arcuate segment extending along an arc, and the at least one of the plurality of the filament feed channels communicates through the arcuate segment with the filament discharge channel.

16. The 3D printer according to claim 13, wherein the plurality of filament feed channels and the filament discharge channel each comprise a straight segment extending along a straight line, and an included angle between an axis of the straight segment of each of the filament feed channels and the axis of the straight segment of the filament discharge channel is an obtuse angle.

17. The 3D printer according to claim 16, wherein the axes of the straight segments of the plurality of filament feed channels are in the same plane or are not coplanar.

18. The 3D printer according to claim 13, further comprising at least one sensor arranged on the wall of the housing for detecting the position of the filament end of the filament in the main filament guide mechanism.

19. The 3D printer according to claim 18, wherein the at least one sensor is at least one Hall sensor, and at least one trigger member is at least one magnet.

20. The 3D printer according to claim 19, further comprising at least one stopping member, wherein each of the stopping member(s) is arranged at one end of a corresponding hole of at least one hole distal to an internal cavity for applying a force to a corresponding magnet of the at least one magnet that prevents the corresponding magnet from moving toward a preset position.
